(19) United States
(12) Patent Application Publication
(10) Pub. No.: US 2025/0252486 A1
(43) Pub. Date: Aug. 7, 2025

(54) SYSTEMS AND METHODS FOR ELIGIBILITY-BASED COST MODELS

(71) Applicant: JPMORGAN CHASE BANK, N.A., New York, NY (US)

(72) Inventors: Nora PENCOLA, Brooklyn, NY (US); Nathaniel MEYER, Plano, TX (US); Nitin RAJORA, Middletown, DE (US)

(21) Appl. No.: 18/429,944

(22) Filed: Feb. 1, 2024

(51) Int. Cl. G06Q 40/03

(52) U.S. Cl. CPC G06Q 40/03

(57) ABSTRACT

Systems and methods for eligibility-based interchange models are disclosed. According to an embodiment, a method for creating an eligibility-based interchange model may include: (1) ingesting, by an eligibility model computer program, interchange data from one or more sources source of interchange data; (2) generating, by the eligibility model computer program, an eligibility-based model using the ingested interchange data; (3) making available, by the eligibility model computer program, the eligibility-based model to a plurality of downstream systems; and (4) monitoring, by the eligibility model computer program, the one or more sources source of interchange data for updates to the interchange data.

### BACKGROUND OF THE INVENTION

### 1. Field of the Invention

Embodiments generally relate to systems and methods for eligibility-based cost models.

### 2. Description of the Related Art

Every credit card and debit card purchase goes through a settlement process to move the corresponding funds from the cardholder to the merchant to accomplish payment for a sale. Settlement is the process of sharing information between issuing and acquiring financial institutions over a payment network to accomplish the funds movement from authorization to clearing. Usually, the merchant receives the amount of the sale discounted by some amount due to fees and assessments paid to various parties for settling the payment. There are three main costs associated with the process of settlement: (1) interchange fees (i.e., fees that are set by the payment brands and retained by the bank that issued the payment card account used in the transaction, generally charged as a percentage of the sale amount plus a fixed fee); (2) assessment fees (fees that are set by the payment brands and are kept by the payment brands); and (3) payment network usage and access fees (fees incurred when the merchant accesses the payment network for various services and are paid to the payment brands). Interchange fees are often the most significant fee that the merchants have to pay for settlement.

Interchange fees are set by the brands and may depend on the type of card (e.g., rewards, debit, etc.), the brand of card, the size of the transaction, the type of merchandise, the type of data that the merchant sends with the transaction, and other factors. The interchange fees charged to the merchant will thus vary significantly, and the complexity of public interchange rates, private rates and other programs is an obstacle to creating a functional data model and algorithm that can be scaled.

### SUMMARY OF THE INVENTION

Systems and methods for eligibility-based interchange models are disclosed. According to an embodiment, a method for creating an eligibility-based interchange model may include: (1) ingesting, by an eligibility model computer program, interchange data from one or more sources source of interchange data; (2) generating, by the eligibility model computer program, an eligibility-based model using the ingested interchange data; (3) making available, by the eligibility model computer program, the eligibility-based model to a plurality of downstream systems; and (4) monitoring, by the eligibility model computer program, the one or more sources source of interchange data for updates to the interchange data.

In one embodiment, the interchange data may be for a plurality of payment brands.

In one embodiment, the interchange data identifies a plurality of interchange programs, and for each of the plurality of interchange programs, may include interchange program qualifications, interchange program rates, and eligible payment types.

In one embodiment, the interchange data may be extracted from historical transactions.

In one embodiment, the eligibility-based model may include rates for the interchange programs offered by brands in regions.

In one embodiment, the method may also include: receiving, by an eligibility engine computer program executed by one of the downstream systems, a plurality of transaction records for a plurality of transactions for a merchant, each of the plurality of transaction records associated with an actual interchange cost; identifying, by the eligibility engine computer program and for each of the plurality of transaction records, an alternate interchange cost using the eligibility-based model; and determining, by the eligibility engine computer program and for each of the plurality of transaction records, an optimal interchange cost as the lower cost of the actual interchange cost and the alternate interchange cost.

In one embodiment, the method may also include: determining, by the eligibility engine computer program and for the plurality of transaction records, an optimal transaction ratio; comparing, by the eligibility engine computer program, the optimal transaction ratio to a threshold; and implementing, by the eligibility engine computer program, a change in interchange program enrollment for the merchant in response to the optimal transaction ratio being below the threshold.

In one embodiment, the method may also include skipping, by the eligibility engine computer program, transaction records that are for a regulated transaction.

In one embodiment, the method may also include skipping, by the eligibility engine computer program, transaction records that are not a scope of the eligibility-based model.

In one embodiment, the method may also include identifying, by the eligibility engine computer program, the interchange program associated with the optimal interchange cost.

According to another embodiment, a system may include: one or more sources of interchange data; an eligibility-based interchange model computer program executed by a computer processor that may be configured to ingest the interchange data from the one or more sources source of interchange data, to generate an eligibility-based model using the ingested interchange data, and to monitor the one or more sources source of interchange data for updates to the interchange data; and an eligibility engine computer program executed by a downstream system that may be configured to receive a plurality of transaction records for a plurality of transactions for a merchant, each of the plurality of transaction records associated with an actual interchange cost, to identify, for each of the plurality of transaction records, an alternate interchange cost using the eligibility-based model, and to determine, for each of the plurality of transaction records, an optimal interchange cost as the lower cost of the actual interchange cost and the alternate interchange cost.

In one embodiment, the interchange data may be for a plurality of payment brands.

In one embodiment, the interchange data identifies a plurality of interchange programs, and for each of the plurality of interchange programs, may include interchange program qualifications, interchange program rates, and eligible payment types.

In one embodiment, the interchange data may be extracted from historical transactions.

In one embodiment, the eligibility-based model may include rates for the interchange programs offered by brands in regions.

In one embodiment, the eligibility engine computer program may be further configured to determine, for the plurality of transaction records, an optimal transaction ratio, to compare the optimal transaction ratio to a threshold, and to implement a change in interchange program enrollment for the merchant in response to the optimal transaction ratio being below the threshold.

In one embodiment, the eligibility engine computer program may be further configured to skip transaction records that are for a regulated transaction.

In one embodiment, the eligibility engine computer program may be further configured to skip transaction records that are not a scope of the eligibility-based model.

In one embodiment, the eligibility engine computer program may be further configured to identify the interchange program associated with the optimal interchange cost.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for eligibility-based interchange models according to an embodiment;

FIG. 2 illustrates a method for creating an eligibility-based interchange model according to an embodiment;

FIGS. 3A and 3B illustrate a method for optimization of interchange costs according to an embodiment.

FIG. 4 depicts an exemplary computing system for implementing aspects of the present disclosure.

### DETAILED DESCRIPTION OF PREFERRED EMBODIMENTS

Embodiments generally relate to systems and methods for eligibility-based cost models. Embodiments may generate an eligibility model that is based on the structure of specific classes of cost like interchange fees. The model may define the fee programs a transaction is eligible for, so that the optimal option is transparent. This facilitates automation and scaling of cost analytics.

Using the hundreds of data elements that dictate interchange qualification, the eligibility model may select a subset of data elements to permit a minimalist mapping of transaction to market programs. The eligibility model may allow automation and scale of algorithms that capture expertise about merchant business practices and brand programs to allow optimality computation for huge data sets.

Embodiments may provide some of the following: value-add analytics, automated optimality scoring, cost forecasting and what-if simulation, bespoke brand update impact estimates or fee avoidance strategies, improved automation, throughput for counterfactual cost analytics, improved interchange/fee reporting products to create better transparency, Monte Carlo cost simulation for cost of payments for new merchants, what-if analysis for merchant onboard configuration optimization, improved automation for merchant post-install validation by monitoring achievement of optimal interchange, bundled pricing simulation, sensitivity analysis and uncertainty intervals for improved pricing, improved key performance indicator identification and creation for automated anomaly detection.

An end result of eligibility-based modeling may be an assessment of optimality based on cost, or some component of cost, like Interchange. For example, embodiments may return a score, such as an Interchange Optimality Score. The score may be returned as a number (e.g., 1-5, 1-10, 1-100, etc.), as a grade (e.g., A, B, C, D, F), as a binary assessment (e.g., optimal/not optimal), etc.

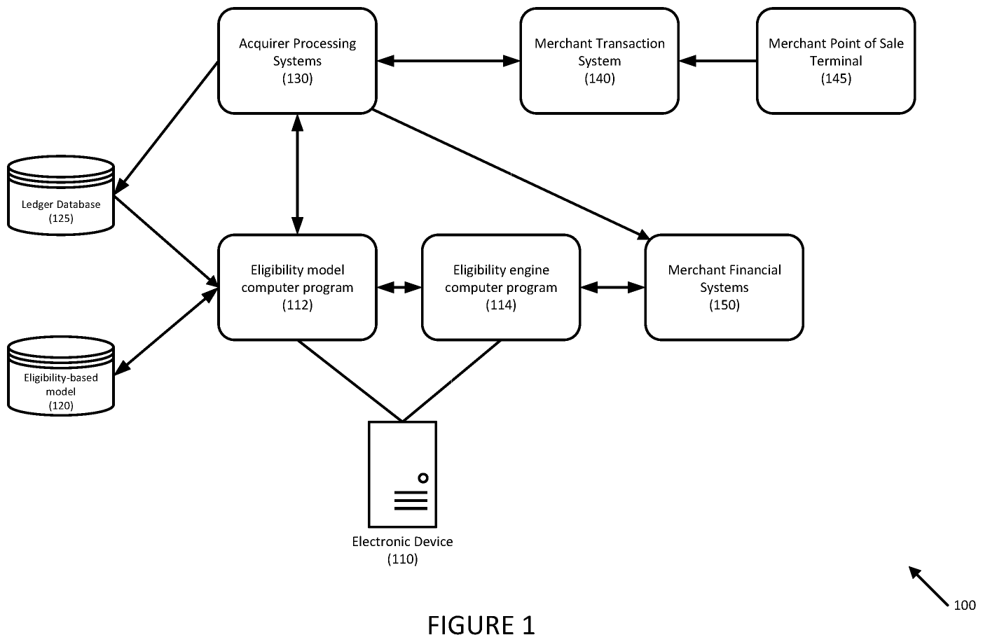

Referring to FIG. 1, a system for eligibility-based interchange models is disclosed according to an embodiment. System 100 may include electronic device 110, which may be a server (e.g., physical and/or cloud-based), computer (e.g., workstation, desktop, laptop, notebook, tablet, etc.), etc. Electronic device 110 may execute eligibility model computer program 112, which may ingest data from one or more ledger database 125 or other sources of interchange data. Using the ledger data in ledger database 125, eligibility model computer program 112 may generate eligibility-based model 120.

Ledger databases 125 may include, for example, ledger data, such as the historical record of the settled payment. Ledger data may include the facts of the transaction including, for example, the merchant, the payment, the fee program used, the fee rate, and the fee amount applied to the payment for each fee applied during settlement.

System 100 may further include acquirer processing systems 130, which may receive a transaction from merchant transaction system 140. Merchant transaction system 140 may receive the transaction from merchant point of sale terminal 145, such as a point-of-sale device, an on-line system, etc. Acquirer processing systems 130 may manage the settlement process and may also generate ledger database 125.

Acquirer processing systems 130 may also provide reporting to merchant financial systems 150. The reporting may include, for example, the facts for each transaction processed by acquirer processing system 130.

Eligibility engine computer program 114 may provide merchant financial systems 150 with optimality-based cost insights for, for example, completed transactions. For example, eligibility engine computer program 114 may score payments in the ledger records of transactions as optimal or not optimal, and may augment those scores with an optimal cost for calculating the opportunity cost of suboptimal fee attainment.

In one embodiment, merchant transaction system 140 and/or merchant point of sale terminal 145 may execute cost-based settlement network routing computer program (not shown) that may implement cost-based settlement optimization based on, for example, eligibility-based model 120. In one embodiment, merchant transaction system 140 and/or merchant point of sale terminal 145 may access eligibility-based model 120 via API or similar; in another embodiment, merchant transaction system 140 and/or merchant point of sale terminal 145 may maintain a copy of eligibility-based model 120.

Merchant transaction system 140 and/or merchant point of sale terminal 145 may select a payment network on which to settle a particular transaction when multiple payment networks are available.

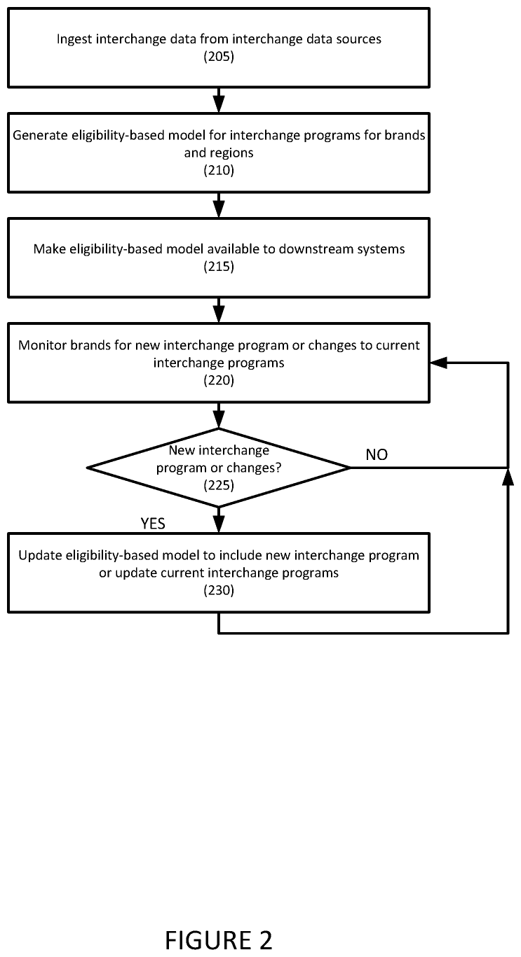

Referring to FIG. 2, a method for creating an eligibility-based interchange model is disclosed according to an embodiment.

In step 205, a computer program, such as an eligibility model computer program, may ingest interchange data from one or more interchange databases or other source of interchange data. In one embodiment, the interchange data may include interchange qualifications manuals for payment brands (e.g., payment networks) for one or more region.

In one embodiment, the interchange data may identify the interchange programs, and for each interchange program, may identify the qualifications for the interchange program (e.g., minimum transaction amounts, minimum transaction numbers, etc.), the interchange program rates, types of eligible payments (e.g., credit, debit, prepaid, commercial, consumer, card present/card not present, contactless, preferred pricing, etc.), spend tiers, etc. It should be noted that each interchange program may have a plurality of interchange program rates (e.g., there may be a different interchange rate for commercial than for consumer).

In one embodiment, interchange data may be extracted from historical transactions conducted by the merchant.

In step 210, the computer program may generate an eligibility-based model using the ingested interchange data. For example, for each brand (e.g., payment network), and for each region, the computer program may create a brand program module for the brand and region. For each region, for each Interchange Program described, the computer program may add a program entry to the brand program module, and, if required, may add a new global MCC lists entry. For each interchange rate offered in a program, the computer program may then add a rate entry to the brand program module.

In step 215, the computer program may make the eligibility-based model available to downstream systems.

In step 220, the computer program may monitor the brands for updates to current interchange programs, or for new interchange programs. In one embodiment, the brand(s) may periodically provide updates on the brand's interchange programs.

If, in step 225, there are updates to current interchange programs, or new interchange programs, in step 230, the computer program may update eligibility-based model to include new interchange program or update current interchange programs. The computer program may then return to monitoring the brands for updates or new interchange programs in step 220.

If there are no updates to current interchange programs or new interchange programs, the computer program may then return to monitoring the brands for updates or new interchange programs in step 220.

The process may be repeated for all interchange program, regions, and brands.

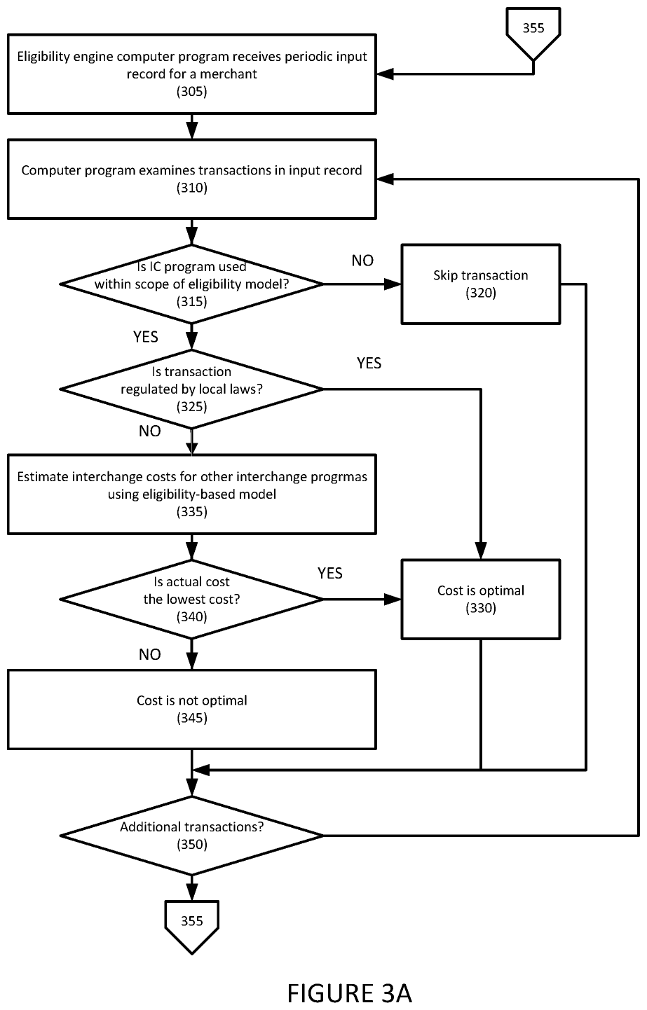

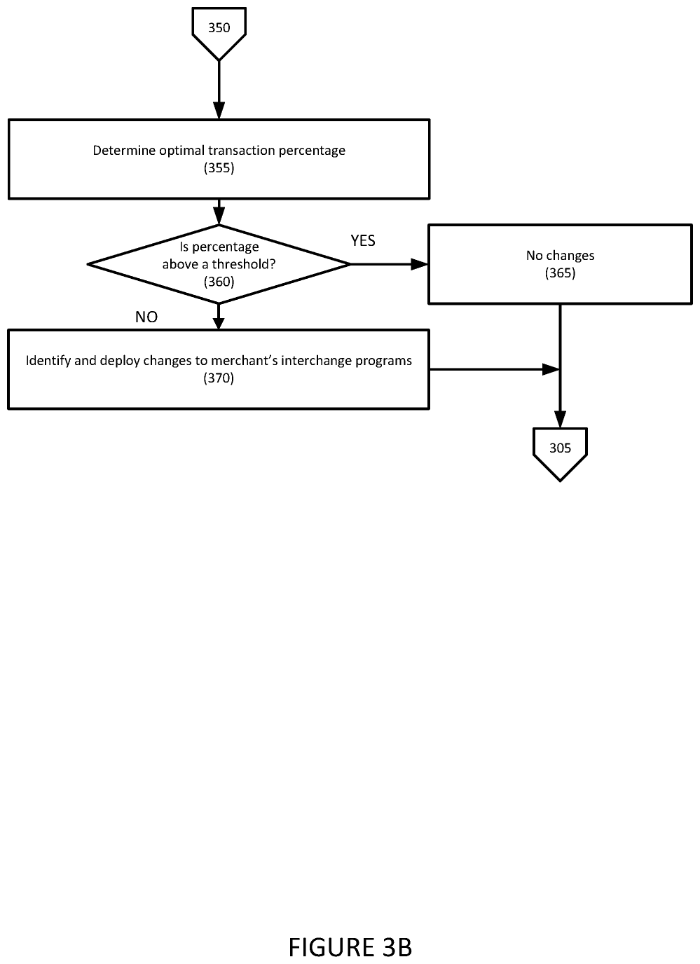

Referring to FIGS. 3A and 3B, a method for optimization of interchange costs is provided according to an embodiment.

In step 305, a computer program, such as an eligibility engine computer program, may receive or retrieve an input record, such as transaction records for a plurality of transactions, from a merchant. The input record may be for a period of time, such as a week, a month, etc. In one embodiment, the transaction records may be from a ledger database, and each transaction may include, for example, a merchant identifier, a payment amount, the interchange fee program used, the interchange fee rate, and the interchange fee amount paid.

In step 310, the computer program may examine the transaction records, and for each transaction record, in step 315, may determine if the interchange program used is within the scope of the eligibility-based model. For example, if the interchange program that was used is not part of the model, in step 320, the transaction may be skipped.

In one embodiment, the interchange program used may be outside the scope of the eligibility-based model if it is a new interchange program. Thus, the new interchange program may be added to the eligibility-based model.

In step 325, a check is made to see if the transaction is regulated by local laws that require the use of the interchange program that was used. If it is, in step 330, the actual cost is the optimal cost.

If the interchange cost is not regulated by local laws, in step 335 the computer program may determine the interchange costs for one or more interchange programs that were not used using the eligibility-based model. This may result in a plurality of alternate interchange costs for the transaction.

If, in step 340, the actual interchange cost is less than or equal to the alternate interchange cost(s), then in step 330, the computer program may identify the actual interchange cost as the optimal interchange cost.

If the actual interchange cost is not less than or equal to the alternate interchange cost(s), in step 345, the computer program may identify the actual interchange cost as not optimal and may identify the interchange program that had the lowest cost.

In step 350, the computer program may determine if there are additional transactions in the input record to evaluate. If there are, the process may return to step 310. If there are not, in step 355, the computer program may determine a percentage or ratio of actual transactions having the optimal interchange cost to the total number of transaction records. In one embodiment, the ratio may exclude skipped transactions.

In step 360, the computer program may compare the optimal transaction ratio to a threshold. The threshold may be set by the acquirer, by the merchant, etc. and may be specific to the merchant. If the optimal transaction ratio is above the threshold, in step 365, no changes to the merchant's programs may be made. If the optimal transaction ratio is below the threshold, in step 370, the computer program may identify changes to the merchant's interchange programs, such as enrolling in a different program, processing certain transactions in a different manner, etc. The changes may be automatically implemented by the acquirer system.

In another embodiment, the changes may be identified by subject matter experts and may then be implemented by the acquirer systems.

The process may then return to step 305, where the next periodic input record may be evaluated. The next periodic input record may include transactions involving the changed merchant interchange programs.

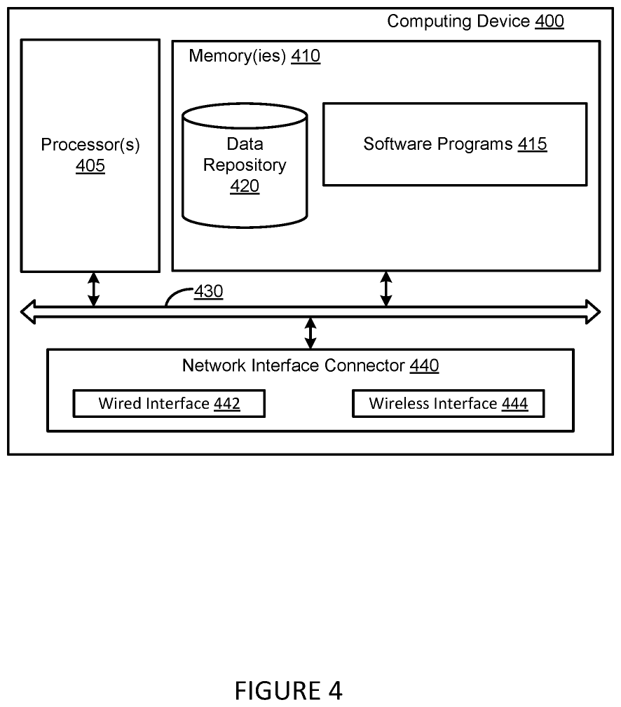

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for creating an eligibility-based interchange model, comprising:
ingesting, by an eligibility model computer program, interchange data from one or more sources source of interchange data;
generating, by the eligibility model computer program, an eligibility-based model using the ingested interchange data;
making available, by the eligibility model computer program, the eligibility-based model to a plurality of downstream systems; and
monitoring, by the eligibility model computer program, the one or more sources source of interchange data for updates to the interchange data.

2. The method of claim 1, wherein the interchange data is for a plurality of payment brands.

3. The method of claim 1, wherein the interchange data identifies a plurality of interchange programs, and for each of the plurality of interchange programs, comprises interchange program qualifications, interchange program rates, and eligible payment types.

4. The method of claim 1, wherein the interchange data is extracted from historical transactions.

5. The method of claim 1, wherein the eligibility-based model comprises rates for the interchange programs offered by brands in regions.

6. The method of claim 1, further comprising:
receiving, by an eligibility engine computer program executed by one of the downstream systems, a plurality of transaction records for a plurality of transactions for a merchant, each of the plurality of transaction records associated with an actual interchange cost;
identifying, by the eligibility engine computer program and for each of the plurality of transaction records, an alternate interchange cost using the eligibility-based model; and
determining, by the eligibility engine computer program and for each of the plurality of transaction records, an optimal interchange cost as the lower cost of the actual interchange cost and the alternate interchange cost.

7. The method of claim 6, further comprising:
determining, by the eligibility engine computer program and for the plurality of transaction records, an optimal transaction ratio;
comparing, by the eligibility engine computer program, the optimal transaction ratio to a threshold; and
implementing, by the eligibility engine computer program, a change in interchange program enrollment for the merchant in response to the optimal transaction ratio being below the threshold.

8. The method of claim 6, further comprising:
skipping, by the eligibility engine computer program, transaction records that are for a regulated transaction.

9. The method of claim 6, further comprising:
skipping, by the eligibility engine computer program, transaction records that are not a scope of the eligibility-based model.

10. The method of claim 6, further comprising:
identifying, by the eligibility engine computer program, the interchange program associated with the optimal interchange cost.

11. A system, comprising:
one or more sources of interchange data;
an eligibility-based interchange model computer program executed by a computer processor that is configured to ingest the interchange data from the one or more sources source of interchange data, to generate an eligibility-based model using the ingested interchange data, and to monitor the one or more sources source of interchange data for updates to the interchange data; and
an eligibility engine computer program executed by a downstream system that is configured to receive a plurality of transaction records for a plurality of transactions for a merchant, each of the plurality of transaction records associated with an actual interchange cost, to identify, for each of the plurality of transaction records, an alternate interchange cost using the eligibility-based model, and to determine, for each of the plurality of transaction records, an optimal interchange cost as the lower cost of the actual interchange cost and the alternate interchange cost.

12. The system of claim 11, wherein the interchange data is for a plurality of payment brands.

13. The system of claim 11, wherein the interchange data identifies a plurality of interchange programs, and for each of the plurality of interchange programs, comprises interchange program qualifications, interchange program rates, and eligible payment types.

14. The system of claim 11, wherein the interchange data is extracted from historical transactions.

15. The system of claim 11, wherein the eligibility-based model comprises rates for the interchange programs offered by brands in regions.

16. The system of claim 11, wherein the eligibility engine computer program is further configured to determine, for the plurality of transaction records, an optimal transaction ratio, to compare the optimal transaction ratio to a threshold, and to implement a change in interchange program enrollment for the merchant in response to the optimal transaction ratio being below the threshold.

17. The system of claim 11, wherein the eligibility engine computer program is further configured to skip transaction records that are for a regulated transaction.

18. The system of claim 11, wherein the eligibility engine computer program is further configured to skip transaction records that are not a scope of the eligibility-based model.

19. The system of claim 11, wherein the eligibility engine computer program is further configured to identify the interchange program associated with the optimal interchange cost.
